(19) United States
(12) Patent Application Publication
(10) Pub. No.: US 2008/0177416 A1
(43) Pub. Date: Jul. 24, 2008

(54) METHOD AND APPARATUS FOR AUTOMATIC CONSTRUCTION OF ELECTRODES FOR ROCKING-MOTION ELECTRIC DISCHARGE MACHINING

(75) Inventors: Kazuhisa Tanimoto, Tokyo (JP); Hideto Kumakura, Tokyo (JP); Yasuhiro Fukushima, Tokyo (JP); Daichi Ninagawa, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: INCS Inc., Kanagawa (JP)

(21) Appl. No.: 11/626,772

(22) Filed: Jan. 24, 2007

(51) Int. Cl. G06F 19/00

(52) U.S. Cl. 700/162

(57) ABSTRACT

Disclosed is a method for designing an electrode for electric discharge machining of a workpiece, based on a reverse shape to a shape of the workpiece by use of a CAD system, which comprises the steps of obtaining a first reverse solid having a reverse shape to a shape of the workpiece, from a solid of the workpiece, uniformly offsetting an entire surface of the first reverse solid by a thickness necessary for a discharge gap to obtain a second reverse solid and subjecting the second reverse solid and one or more swept reverse solids created by copying the second reverse solid while allowing a sweep movement by a small distance in a direction conforming to a rocking motion, to a logical product (AND) operation to obtain a shape of an electrode as a third reverse solid.

### BACKGROUND OF THE INVENTION

1. Field of the Invention

Aspects of the present invention generally relate to a method and apparatus for automatic construction of electrodes for use in rocking-motion electric discharge machining.

2. Description of the Related Art

There has been known a technique of designing electrodes for electric discharge machining by use of a 3-dimensional CAD system, as disclosed, for example, in Japanese Patent Laid-Open Publication No. 05-92348.

This publication discloses a technique intended to automatically draw a figure of a shape of an electrode for rocking-motion electric discharge machining, based on a shape of a workpiece (i.e., target to be machined) by use of a CAD system. Specifically, in a process of designing an electric discharge machining electrode (hereinafter referred to shortly as “electrode”) for use in an electric discharge machine designed to perform electric discharge machining while rocking an electrode in a direction perpendicular to a machining direction (typically Z-axis direction) (this electric discharge machining process will hereinafter be referred to as “rocking-motion electric discharge machining process” or to shortly as “rocking machining”), the technique comprises defining a shape of a workpiece as a 2-dimensional or 3-dimensional solid, creating a shape offset from the workpiece shape by a distance equal to a discharge gap, translating the offset shape to respective edge points by a rocking distance according to a rocking pattern to copy the translated shapes, and subjecting copied solid shapes to a set operation so as to automatically draw a shape of an electrode.

More specifically, according to the above technique, in a process of designing an electrode for machining a workpiece 101a (top view), 101b (side view) with a holed shape having a target surface 101c as shown in FIG. 1(a), the original shape of the workpiece is firstly offset by a distance for assuring a discharge gap 103 to create an offset shape as shown in FIG. 1(b), and the offset shape is revered to create a reverse shape as shown in FIGS. 1(c). Then, as shown in FIG. 2, the reverse shape (105, 201) is translationally copying (203) in accordance with an intended rocking motion, and a plurality of copied shapes are subjected to an “logical product operation (AND operation)” to obtain a shape (205) as a shape of an electrode, as shown in FIG. 1(d).

In a process of designing an electrode for machining a workpiece 301a (top view), 301b (side view) with a convex shape having a target surface 301c as shown in FIG. 3(a), the original convex shape is firstly offset by a distance for assuring a discharge gap 303 to create an offset shape as shown in FIG. 3(b), and the offset shape (401) is translationally copying (403) in accordance with an intended rocking motion as shown in FIG. 4. Then, a plurality of copied shapes are subjected to a “logical sum operation (OR operation)”, and an obtained shape (405) is reversed to provide a reverse shape as a shape of an electrode.

(According to the above technique, in a workpiece with a convex shape, a shape offset from the original convex shape in consideration of a discharge gap is subjected to copying an a logical sum operation. Then, a reverse shape is obtained as a shape of an electrode. That is, the modified shape of the workpiece is reversed in the final stage, and thereby the set operation must be the “logical sum operation”. The shape being translated in FIG. 4 is a shape associated with the workpiece.)

As above, in the conventional technique (disclosed in the above publication), the offset shape is created from an original shape of a workpiece in consideration of a discharge gap, irrespective of whether the workpiece has a holed shape or a convex shape. Then, as to the holed shape, the offset shape is reversed, and subjected to translational copying depending on an intended rocking motion and a logical product operation. As to the convex shape, the offset shape is subjected to translational copying depending on an intended rocking motion and a logical sum operation, and then reversed. That is, the technique disclosed in the above publication is required to use different processes/methodologies depending on whether a workpiece has a holed shape or a convex shape, and additionally take a polygonal solid into consideration for the convex shape.

### SUMMARY OF THE INVENTION

The technique disclosed in the above publication cannot be used for automatically designing electrodes for 3-dimensional electric discharge machining. The reason is that the publication discloses only an operation on the X-Y plane (horizontal plane) but does not include any description about an operation to be executed when the disclosed operation is further developed into the Z direction (3-dimensional operation).

Moreover, the type of set operation must be changed between a logical product operation and a logical sum operation depending on whether a workpiece (i.e., target to be machined) has a holed (concaved) shape or a convex shape, to cause complexity in design work.

Further, in a workpiece (i.e., target to be machined) having a convex shape, it is necessary to perform a complicated processing of generating a polygonal solid in conformity to a contour configuration, and adding the polygonal solid to the result of the set operation.

In view of the above problems of the technique disclosed in the above publication, it is an object of the present invention to provide a technique of creating a model in consideration of both a discharge gap and a rocking distance, precisely and in a simplified manner, irrespective of workpiece shapes.

In order to achieve the above object, as set forth in the appended claim 1, the present invention provides a method for designing an electrode for electric discharge machining of a workpiece, based on a reverse shape to a shape of the workpiece by use of a CAD system, which comprises the steps of (a) obtaining a first reverse solid having a reverse shape to a shape of the workpiece, from a solid of the workpiece, (b) uniformly offsetting an entire surface of the first reverse solid by a thickness necessary for a discharge gap to obtain a second reverse solid, and (c) subjecting the second reverse solid and one or more swept reverse solids created by copying the second reverse solid while allowing a sweep movement by a small distance in a direction conforming to a rocking motion, to a logical product (AND) operation to obtain a shape of an electrode as a third reverse solid.

In a preferred embodiment of the present invention set forth in the appended claim 1, as set forth in the appended claim 2, the step (a) of obtaining the first reverse solid includes the step of defining the workpiece shape as target region to be subjected to electric discharge machining and a non-target region to be not subjected to electric discharge machining, and, during creating the reverse shape, offsetting the non-target region by a discharge escape distance without subjecting the target region to the offsetting.

In this embodiment, the offset can be set in consideration of the discharge escape distance in the step (a) of obtaining the first reverse solid. This provides an advantage of being able to eliminate an operation of comparing a finally obtained electrode shape with a workpiece shape to remove a region unnecessary for electric discharge machining.

In another preferred embodiment, as set forth in the appended claim 3, the method set forth in the appended claim 1 further includes the step of, after the step (c) of obtaining the shape of the electrode, calculating a sum of the shape of the electrode and a shape of an electrode blank including a square pole shape and a cylindrical shape, to obtain an integral shape of the electrode and the electrode blank.

in this embodiment, a fabrication path may be formed in the obtained electrode shape using a CAM system to provide an advantage of being able to immediately star fabricating the electrode. In addition, the integrated electrode shape can be virtually moved relative the workpiece shape on the CAD system to simulate an actual machining operation, such as an inspection on whether the electrode interferes with the workpiece.

In another preferred embodiment, as set forth in the appended claims 4 to 6, the method set forth in each of the appended claim 1 to 3 includes allowing the electrode to be automatically redesigned when a part of dimension of the workpiece including a hole diameter is changed, by use of, in each of the steps (a) to (c) of obtaining the first to third reverse solids, at least three types of information consisting of (i) information about a region of the workpiece solid which has been used in the step (a) of obtaining the first reverse solid, (ii) information about an offset value of each surface of the first reverse solid which has been offset in the step (b) of obtaining the second reverse solid, and (iii) information about a sweep direction of each slid which has been subjected to the sweep movement, and a combination of the solids which have been subjected to the logical product operation, in the step (c of obtaining the third reverse solid.

In this embodiment, during a redesign process, data is automatically changed without staring a design procedure from the beginning. Thus, a fabrication path may be formed immediately after dimensional change of the workpiece to provide an advantage of being able to immediately start fabricating the electrode.

In another preferred embodiment, as set for the in the appended claim 7, the method set forth in the appended claim 1 further includes the step of extracting machining information necessary for the electric discharge machining including a machining start position of the electrode, a rocking distance and a rocking direction, from information about the electrode and the workpiece, and automatically transmitting the extracted machining information to an electric discharge machine.

This embodiment provides an advantage of being able to initiate the electric discharge machining after a setup operation of fixing a fabricated electrode and a workpiece to an electrode holder and a table, respectively.

In another preferred embodiment, as set forth in the appended claim 8, in the method set forth in the appended claim 1, the step (c) of obtaining the third reverse solid includes the step of, when a target region of the workpiece to be machined by the electrode includes no curved area and an edge which extends between respective points of two maximum values or two minimum values to have a length greater than a rocking distance in a rocking direction and a parallel relation to the rocking direction, calculating a product of the second reverse solid and a solid created by copying and translating the second reverse solid by the rocking distance.

This embodiment provides an advantage of being able to quickly create an electrode shape in consideration of a rocking motion without a logical product operation of reverse solids copied bit by bit.

As set forth in the appended claim 9, the present invention also provides an apparatus for designing an electrode for electric discharge machining of a workpiece, based on a reverse shape to a shape of the workpiece by use of a CAD system, which comprising: (a) first-reverse-solid processing means operable to obtain a first reverse solid having a reverse shape to a shape of the workpiece, from a solid of the workpiece, (b) second-reverse-solid processing means operable to uniformly offset an entire surface of the first reverse solid by a thickness necessary for a discharge gap to obtain a second reverse solid, and (c) electrode-shape processing means operable to subject the second reverse solid and one or more swept reverse solids created by copying the second reverse solid while allowing a sweep movement by a small distance in a direction conforming to a rocking motion, to a logical product (AND) operation to obtain a shape of an electrode as a third reverse solid.

The definition of terms used in this specification will be described in the following Table 1.

TABLE 1
Definition of Terms Used in This Specification

| Term | Definition | Note |
|---|---|---|
| C surface | A chamfered surface formed along an intersection edge between two | FIG. 5 |
| | surface to have an angle of 45° with each of the surfaces | |
| R surface | A rounded surface formed along an intersection edge between two | |
| | surface to have a constant radius | |
| Offset distance | An amount of displacement for displacing an edge, a surface or a solid | |
| | in a certain direction while maintaining a shape thereof | |
| Copying | To making one or more duplicates from a shape having information or | |
| | a record thereof, While maintaining information itself, in a data form | |
| | identical thereto or out of the identical level | |
| Surface (model) | A shape consisting of a surface and having no volume | |
| Sweeping | To push out a surface or a solid along a curve for guiding it | FIG. 6 |
| Solid (model) | A shape having a volume | |
| Taper surface | A surface having an angle (which is not zero degree) with the X-Y | FIG. 7 |
| | plane, X-Z plane or Y-Z plane | |
| Trimming | A state in which two lines, surfaces or solids intersect with each other | FIG. 8 |
| | while cutting away excess portions thereof on the basis of a line of | |
| | intersection therebetween | |
| Fillet | An R surface formed to round an intersection edge between two | FIG. 9 |
| | surfaces | |
| Blank | A seat for supporting a tip shape of an electrode, or a raw material | |
| | before machining | |
| Wire frame (model) | A shape consisting only of an edge having no surface | |
| Workpiece | A general term of an object to which a certain shape is to be given (the | |
| | term referring to any object to be finally finished to have a certain | |
| | shape irrespective of before and after machining) | |
| Minimum value | A lowermost point of a concave shape | FIG. 10 |
| Maximum value | An uppermost point of a convex shape | FIG. 10 |
| Holed shape | A concaved shape or penetrated shape existing in a solid | |
| Set operation | A logical sum, difference or product operation to be performed to two | |
| | or more solid | |
| Logical product operation | A logical operation for arithmetically obtaining an overlapping region | |
| | of two or more surfaces or solids | |
| Electrode blank | Referring to FIG. 11, when an electrode having a shape created through | FIG. 11 |
| | the steps (b) to (d) of the appended claim 1 is attached to an electric | |
| | discharge machine while being held by a jig (i.e., a tool for attaching | |
| | the electrode to an electric discharge machine while fixedly clamping | |
| | the electrode), a seat is attached to the electrode to facilitate the holding | |
| | of the jig. This seat is referred to as “electrode blank”. | |
| Convex shape | A protruding shape existing in a solid | |
| Translational copying | To copy an original shape along a given axis while maintaining a | |
| | direction of the original shape relative to the axis | |
| Discharge gap | A distance to be set to generate a potential difference between an | |
| | electrode and a workpiece (a value of the discharge gap is varied | |
| | depending on machining conditions). This term is also referred to as | |
| | “machining amount”. | |
| Electric discharge | A process of applying a voltage between a workpiece and an electrode | |
| machining | to induce an electric discharge therebetween and melt a part of a | |
| | workpiece by resulting heat. When the electric discharge machining | |
| | is performed using an electrode having a reverse shape to a desired | |
| | shape, a workpiece is machined in such a manner that the electrode | |
| | shape is transferred to the workpiece. In this case, it is necessary to | |
| | design the electrode in consideration of both a discharge gap and a | |
| | rocking distance, instead of creating the reverse shape by simply | |
| | reversing a workpiece shape. | |
| Electric discharge | A machine designed to automatically set a position of an electrode | |
| machine | according to a predetermined program, and perform electric discharge | |
| | machining between the electrode and a workpiece to transferably | |
| | machine the workpiece in a desired shape. | |
| Discharge escape | A distance between a workpiece surface and an electrode, which is | FIG. 12 |
| distance | necessary to prevent occurrence of an electric discharge phenomenon | |
| | when the workpiece includes a region, which should not be subjected to | |
| | electric discharge machining. The discharge escape distance is | |
| | different from an after-mentioned rocking distance and the discharge | |
| | gap. Specifically, when a solid of a workpiece includes a region | |
| | which has been subjected to a cutting process or a machining process | |
| | using another electrode and thereby should not be re-subjected to | |
| | electric discharge machining, an electrode is designed to keep a given | |
| | distance from the region to allow the region to escape from electric | |
| | discharge machining. This distance is referred to as “discharge escape | |
| | distance”. | |
| Rocking distance | A rocking-motion electric discharge machining is performed while | |
| | rocking an electrode, to discharge chips. A distance of the rocking | |
| | (rocking motion) of the electrode is referred to as “rocking distance”. | |
| | The rocking distance is required to be determined depending on a | |
| | rocking pattern. There is the following relationship an electrode | |
| | shape = a reverse shape of a workpiece - a discharge gap/a rocking | |
| | distance(Formula(1)). | |
| Recording | A design-work procedure of modeling on a CAD system | |
| Logical sum operation | A logical operation for arithmetically obtaining a region where two or | |
| | more surface and/or solids exist | |

As above, according to the present invention, a model can be created in consideration of both a discharge gap and a rocking distance, precisely and in a simplified manner, irrespective of workpiece shapes.

### BRIEF DESCRIPTION OF THE DRAWINGS

FIGS. 1(a) to 1(d) are explanatory diagrams showing a process of creating a shape of discharge electrode for a workpiece having a holed shape, according to a conventional technique.

FIG. 2 is an explanatory diagram showing a step of translationally copying a reversed workpiece shape by a rocking distance and subjecting copied shapes to a logical product operation, in the conventional technique.

FIGS. 3(a) and 3(b) are explanatory diagrams showing a process of creating a shape of a discharge electrode for a workpiece having a convex shape, according to the conventional technique.

FIG. 4 is an explanatory diagram showing a step of offsetting an original workpiece shape by a discharge gap, translationally copying the offset workpiece shape by a rocking distance, and subjecting copied shapes to a logical sum operation, in the conventional technique.

FIG. 5 is an explanatory diagram of “C surface”.

FIG. 6 is an explanatory diagram of “sweeping”.

FIG. 7 is an explanatory diagram of “taper surface”.

FIG. 8 is an explanatory diagram of “trimming”.

FIG. 9 is an explanatory diagram of “fillet”.

FIG. 10 is an explanatory diagram of “minimum value” and “maximum value”.

FIG. 11 is an explanatory diagram of “electrode blank”.

FIG. 12 is an explanatory diagram of “discharge escape distance”.

FIGS. 13(a) and 13(b) are diagrams showing respective examples of offsetting in a fillet and a C surface for a discharge gap.

FIGS. 14(a) and 14(b) are diagrams showing respective examples of offsetting in a fillet and a C surface for a rocking distance.

FIGS. 15(a) to 15(c) are explanatory diagrams showing a step of creating a reverse shape offset by a discharge gap when a workpiece has a holed shape, in a method according to one embodiment of the present invention.

FIG. 16 is an explanatory diagram showing a step of allowing the reverse shape in FIG. 15(c) or FIG. 17(c) to have a sweep movement by a rocking distance, and subjecting resulting swept shapes to a logical product operation, in the method according to the embodiment of the present invention.

FIG. 17(a) to 17(c) are explanatory diagrams showing a step of creating a reverse shape offset by a discharge gap when a workpiece has a convex shape, in the method according to the embodiment of the present invention.

FIG. 18 is a flowchart schematically showing a process in the method according to the embodiment of the present invention.

FIG. 19 is a flowchart specifically showing the process in the method according to the embodiment of the present invention.

FIG. 20 is an explanatory diagram showing the configuration of a system according to one embodiment of the present invention.

FIG. 21 is an explanatory diagram showing a techniques (1) of extracting machining information necessary for electric discharge machining which includes a machining start position of an electrode, a rocking distance and a rocking direction, from information bout the electrode and workpiece, and automatically transmitting the extracted machining information to an electric discharge machine.

FIG. 22 is an explanatory diagram showing a technique (2) of extracting machining information necessary for electric discharge machining which includes a machining start position of an electrode, a rocking distance and a rocking direction, from information about the electrode and a workpiece, and automatically transmitting the extract machining information to an electric discharge machine.

FIG. 23 is an explanatory diagram showing a technique (3) of extracting machining information necessary for electric discharge machining which includes a machining start position of an electrode, a rocking distance and a rocking direction, from information about the electrode and a workpiece, and automatically transmitting the extracted machining information to an electric discharge machine.

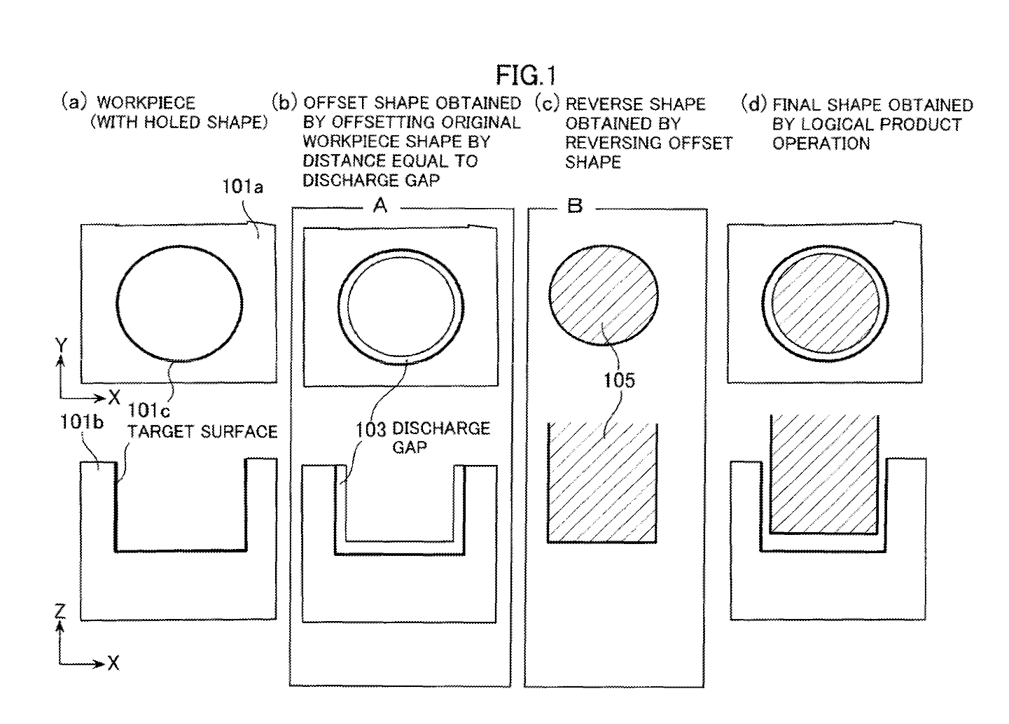

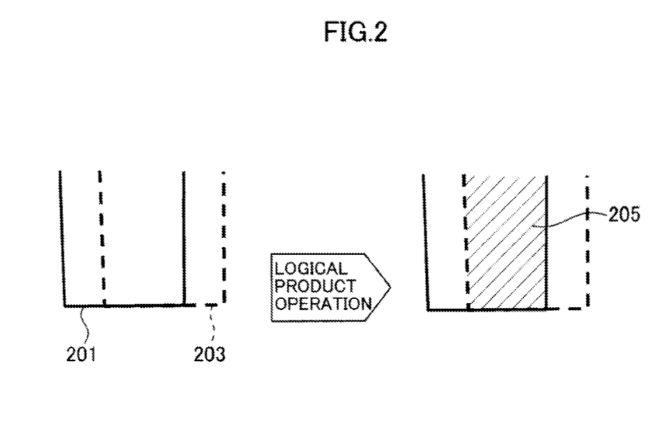

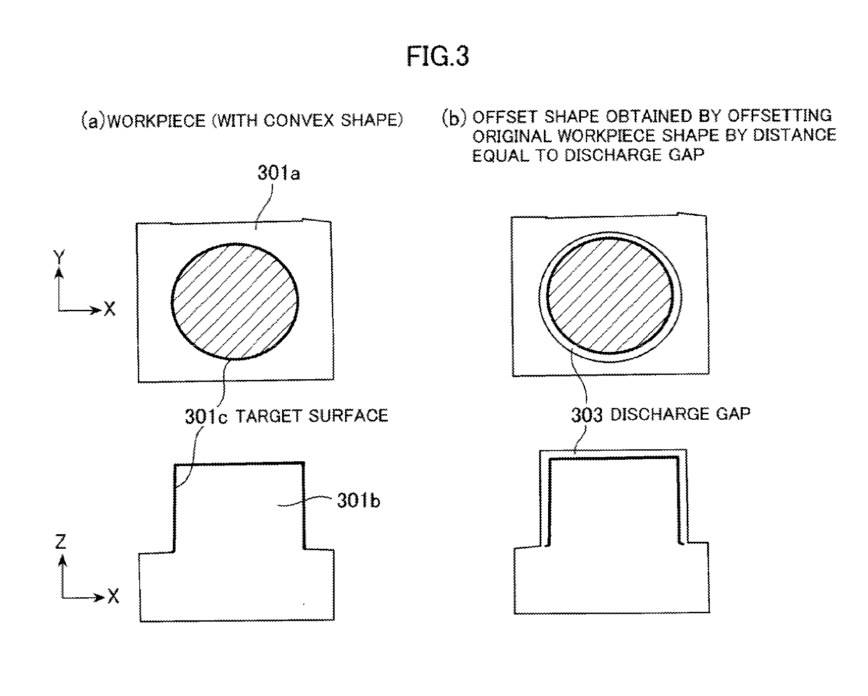

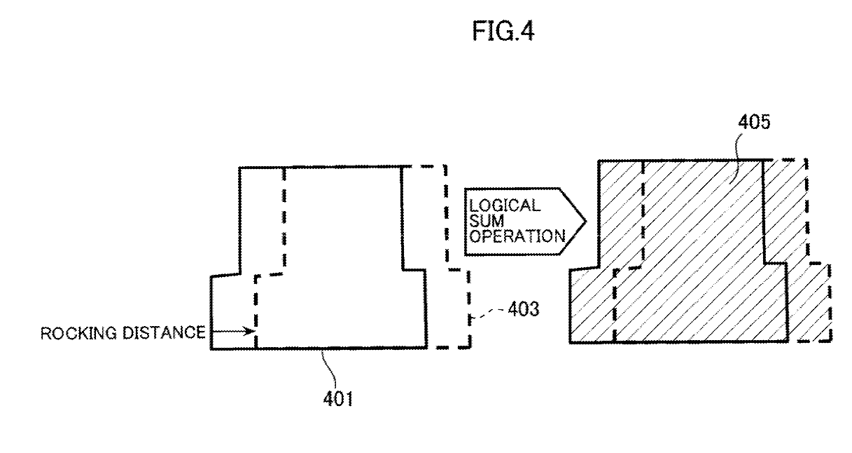

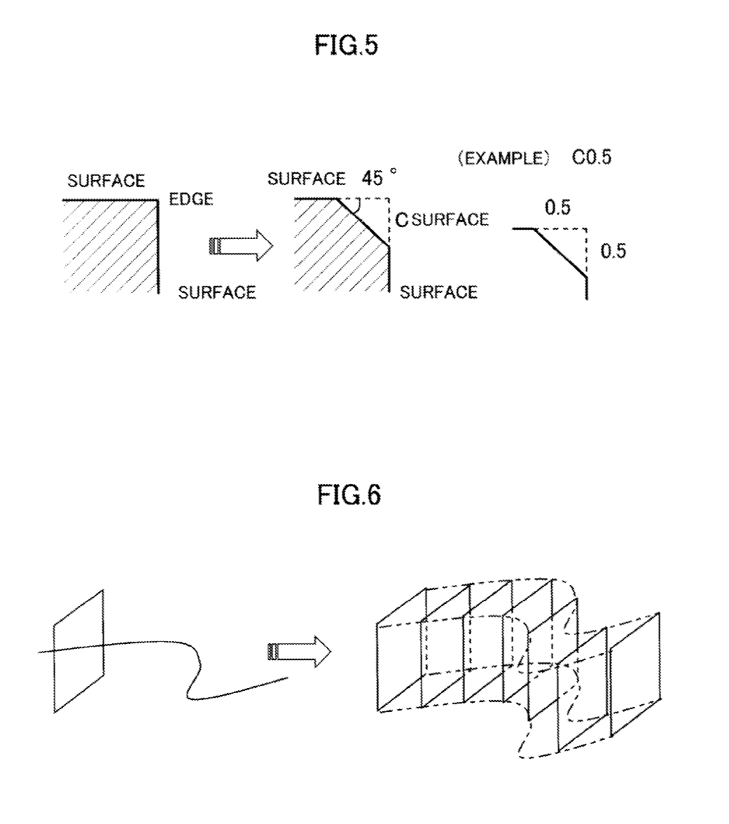

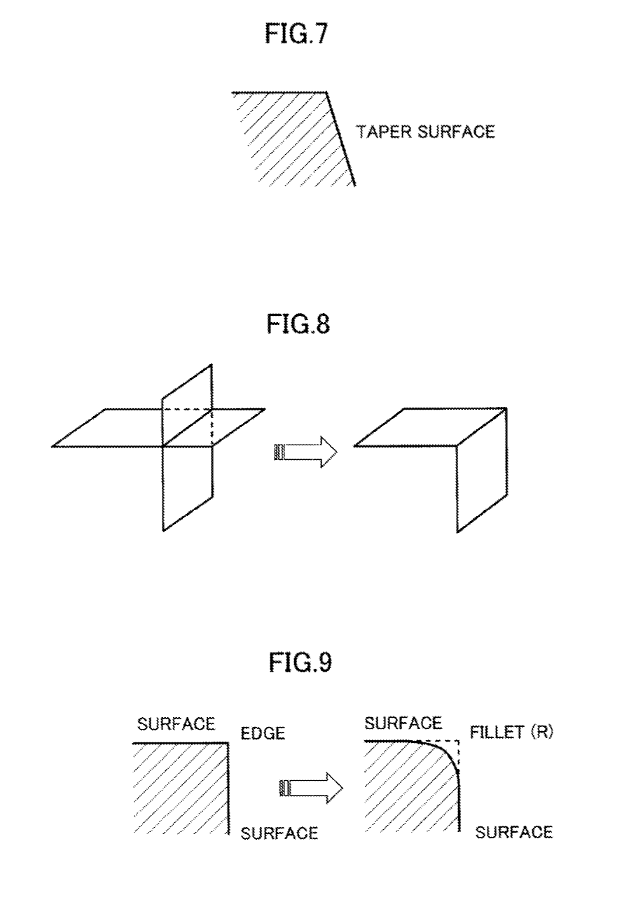

### DESCRIPTION OF THE PREFERRED EMBODIMENTS OF THE INVENTION

Firstly, a method for designing electrodes for electric discharge machining will be generally described.

Electrode Design: Discharge Gap

A discharge gap is uniformly set to the entire target surface (i.e., workpiece surface to be subjected to electric discharge machining) in a normal direction relative to the target surface (inform offset). For example, given than an offset value is 0.02 mm, a diameter in a lateral surface: 5.00−0.02×2=4.94, and a curvature radius of a fillet: R 1.10−0.02=R 0.98. Each of a C surface and a taper surface is offset in a normal direction thereof.

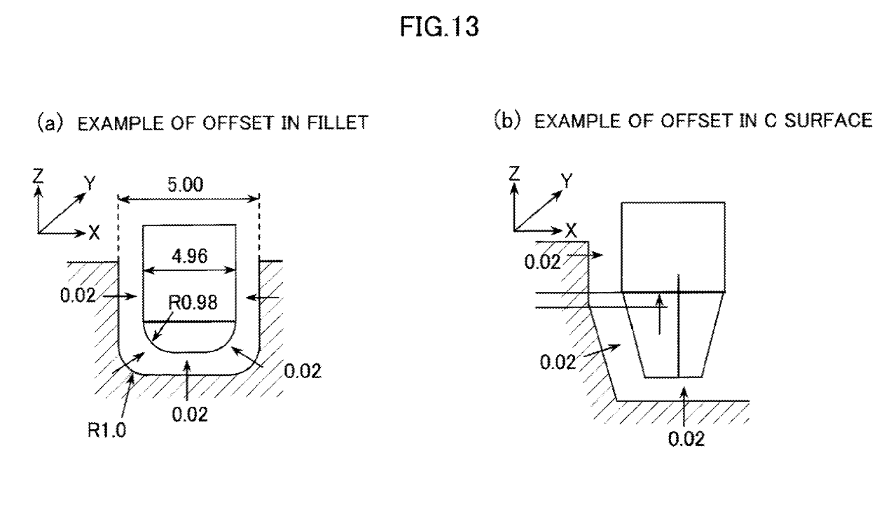

In an example of offsetting in a fillet illustrated in FIG. 13(a), each of a lateral surface, a bottom surface and a fillet is offset by 0.02 mm in a normal direction thereof. Thus, the R value of the fillet is reduced by 0.02 mm.

In an example of offsetting in a taper surface illustrated in FIG. 13(b), each of a lateral surface, a fillet and a bottom surface is offset by 0.02 mm in a normal direction thereof. In conjunction with the offsetting, an edge is moved in the Z-direction.

As above, as to the discharge gap, the offsetting fundamentally involves “increase or decrease in size” or “decrease in convex R” and “increase in concave R”.

Electrode Design: Rocking Distance

A rocking distance is set only in a rocking direction. As to a rocking motion in the X-Y direction, the rocking distance is set only in the X-Y direction.

For example, given that the rocking distance is 0.1 mm, a diameter of a lateral surface: 5.00−0.1×2=4.80, and a fillet is maintained (a shape of the fillet is not changed). Each of a C surface and a taper surface is translated, and therefore a position thereof in the Z-direction is maintained.

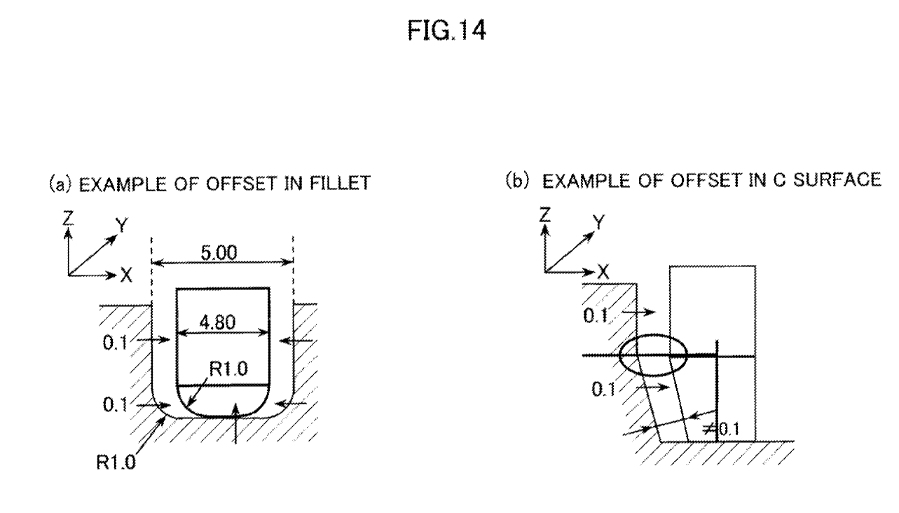

In an example of offsetting in a fillet illustrated in FIG. 14(a), each surface is offset in a horizontal direction. Thus, a height dimension of a bottom surface is not changed. An offset value of each surface is 0.1 mm equal to the rocking distance, and an R surface is offset in the X-Y direction while maintaining the R value.

In an example of offsetting in a taper surface illustrated in FIG. 14(b), a taper surface is offset by 0.1 mm in a horizontal direction (instead of a normal direction). Further, a height dimension of an edge in the taper surface is maintained.

As above, as to the rocking distance, the offsetting fundamentally involves “translation”.

Embodiment of the Present Invention

One embodiment of the present invention will now be specifically described.

Workpiece with Holed Shape

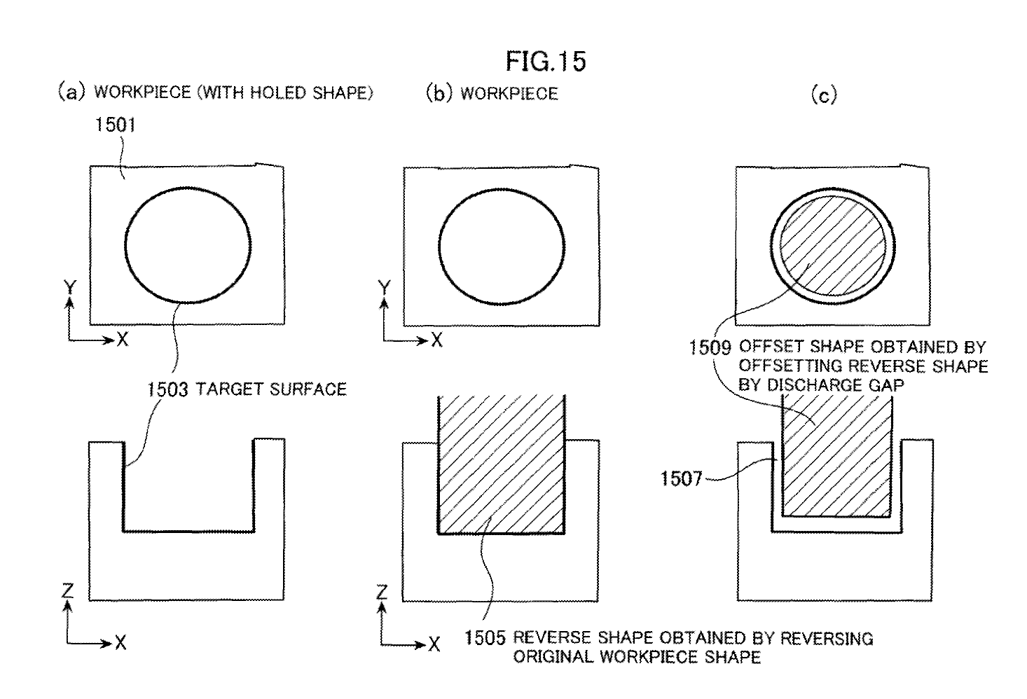

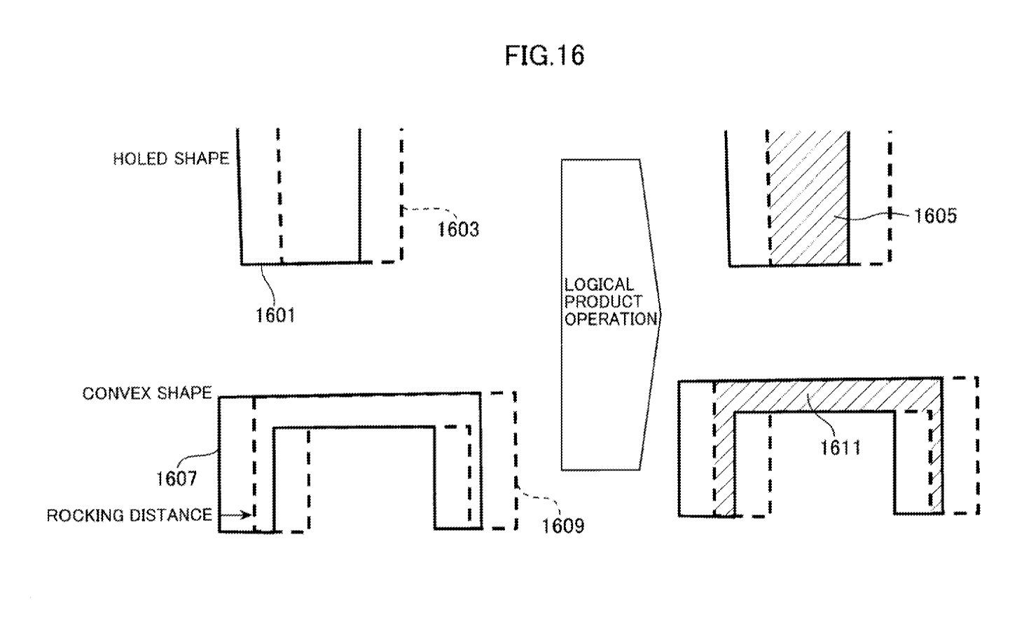

A process for a workpiece having a holed shape will be described with reference to FIGS. 15(a) to 15(c). Firstly, a reverse shape is calculated as shown in FIG. 15(b) from a workpiece as shown in FIG. 15(a) (1501 (top view), 1503 (side view)). Then, a discharge gap 1507 is added to the reverse shape in FIG. 15(b) to obtain a shape as shown in FIG. 15(c). Then, in order to assure a rocking distance, the reverse shape (1601) in FIG. 16 is translationally copied by the rocking distance to obtain a translationally copied shape (1603), and the reverse shape (1601) and the translationally copied shape (1603) are subjected to a logical product operation to obtain an electrode shape (1605).

In this process, instead of translationally copying the reverse shape (1601) in FIG. 16 by a certain rocking distance to obtain the translationally copied shape (1603), it is preferable to divide a desired rocking distance into a plurality of small distances, and subject the reverse shape (1601) and a plurality of shapes copied while translating the reverse shape stepwise by the small distance, to a logical product operation.

Workpiece with Convex Shape

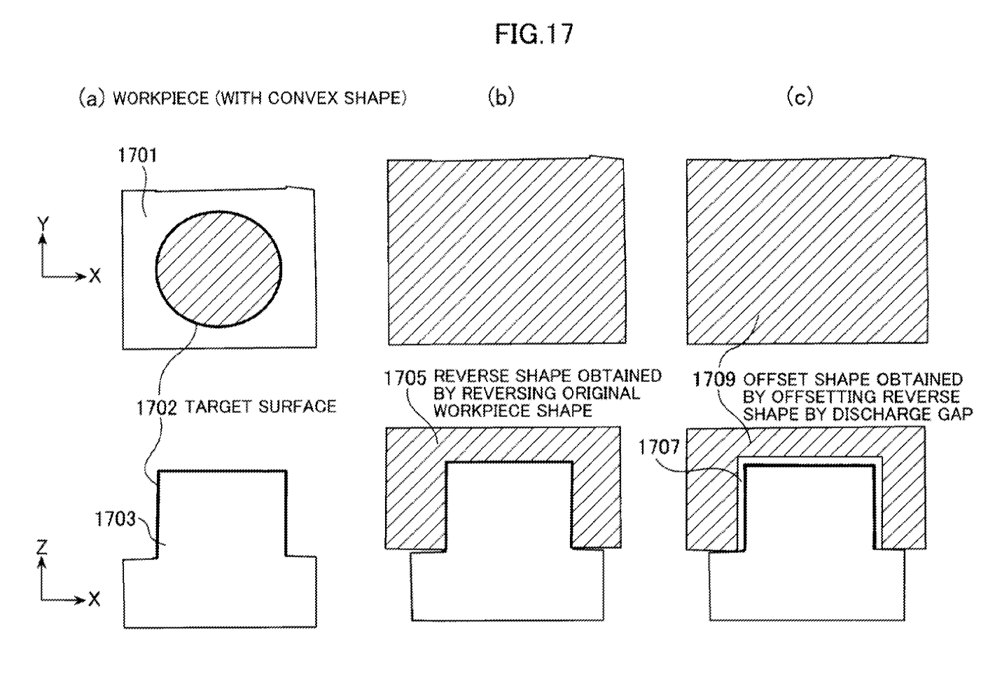

Firstly, a reverse shape is calculated as shown in FIG. 17(b) from a workpiece as shown in FIG. 17(a) (1701 (top view), 1703 (side view)). Then, a discharge gap 1707 is added to the reverse shape in FIG. 17(b) to obtain a shape as shown in FIG. 17(c).

Then, in order to assure a rocking distance, the reverse shape (1607) in FIG. 16 is translationally copied by the rocking distance to obtain a translationally copied shape (1609), and the reverse shape (1607) and the translationally copied shape (1609) are subjected to a logical product operation to obtain an electrode shape (1611).

In the process, instead of translationally copying the reverse shape (1607) in FIG. 16 by a certain rocking distance to obtain the translationally copied shape (1603), it is preferable to divide a desired rocking distance into a plurality of small distances, and subject the reverse shape (1607) and a plurality of shapes copied while translating the reverse shape stepwise by the small distance, to a logical operation.

Feature of Embodiment of the Present Invention

As above, the embodiment of the present invention is definitely different from the conventional technique, in the point of, irrespective of whether a workpiece has a holed shape or a convex shape, creating a reverse shape from a workpiece shape, offsetting the “reverse shape to the workpiece shape” by a discharge gap, and subjecting the offset shape of the “reverse shape to the workpiece shape” and one or more shapes obtained by copying the offset shape of the “reverse shape to the workpiece shape” which is moved by a rocking distance in a rocking direction, to a logical product operation to design a discharge electrode.

In this point, the conventional technique is designed to perform a processing using the “workpiece shape” just before the final step. (In the embodiment of the present invention, after a reverse shape is obtained from a workpiece shape in the initial step, the “workpiece shape” will never be used in subsequent steps. This is a difference from the conventional technique.)

The conventional technique is required to selectively use a logical product operation and a logical sum operation depending on whether a workpiece has a holed shape or a convex shape. Moreover, as mentioned above, the conventional technique cannot be used in a 3-dimensional design. While the conventional technique can achieve an optimal 2-dimensional design for an electrode having a holed shape, it is necessary to take a polygonal solid into consideration for a convex shape.

In contrast, the above embodiment of the present invention makes it possible to create a model in consideration of both a discharge gap and a rocking distance, precisely and in a simplified manner (without selectively using a logical product operation and a logical sum operation), irrespective of workpiece shapes (irrespective of whether a workpiece has a holed shape or a convex shape).

Flowchart

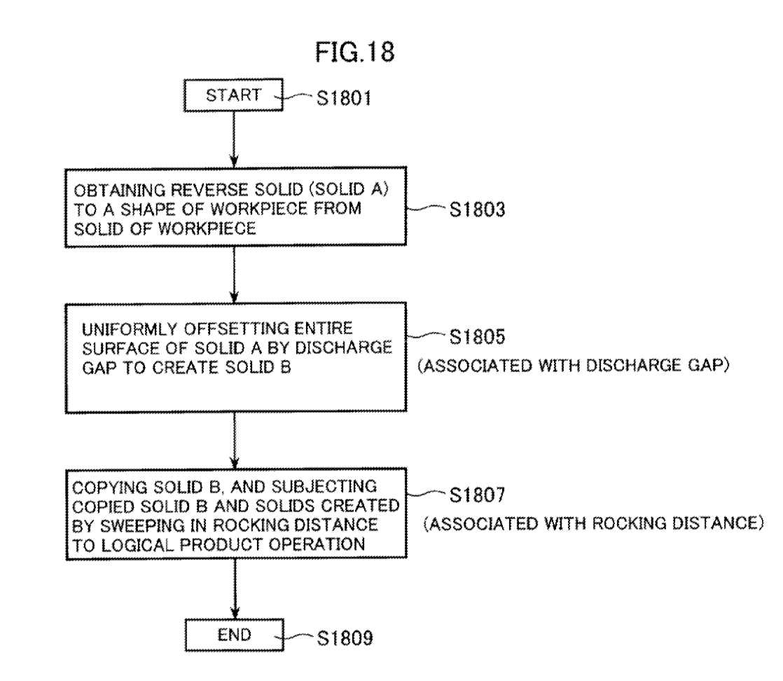

With reference to the flowchart in FIG. 18, a process flow in the embodiment of the present invention will be described below.

The process is initiated in Step S1801.

Then, in Step S1803, a reverse solid to a workpiece shape is calculated from a workpiece solid (to obtain a solid A).

In Step S1805, the entire surface of the solid A is uniformly offset by a discharge gap (to obtain a solid A).

In Step S1807, the solid B is copied while sweeping in a rocking direction, and the solid B and swept shapes are subjected to a logical product operation. In this step, a rocking distance can be associated with the model.

In Step S1809, the process is terminated.

Detailed Flowchart

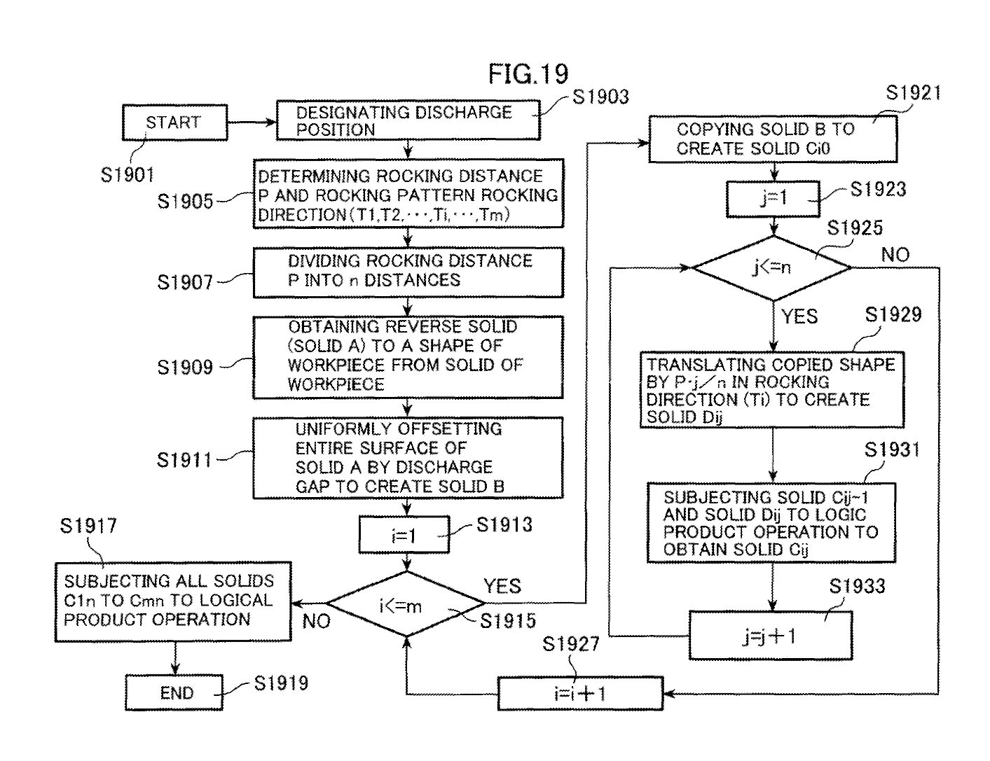

With reference to the flowchart in FIG. 19, the process flow in the embodiment of the present invention will be more specifically described below.

In Step S1901, the process is initiated.

In Step S1903, a discharge position is designated.

In Step S1905, a rocking distance P and a rocking pattern are determined (rocking direction: T1, T2, . . . , Ti, . . . , Tm).

In Step S1907, the rocking distance is divided into n distances.

In Step S1909, the reverse solid to workpiece shape is calculated from a workpiece solid (to obtain a solid A).

In Step S1911, the entire surface of the solid A is uniformly offset by a discharge gap (to obtain a solid B).

In Step S1913, “i” is set to “1”.

In Step S1915, it is determined whether “i” is equal to or less than “m” (m is a maximum value (MAX value) of the number of rocking directions. When there are four rocking directions m=4).

If NO in Step S1915 (i.e., if a processing for the entire rocking directions has been completed), the process advances to Step S1917, and solids Cin to Cmn are subjected to a logical product operation. That is, all of processing results of the entire rocking directions are subjected to a logical product operation. For example, given that n=1, this operation is performed to calculate a product of an original shape and a shape obtained by copying the original shape and translating the copied shape i the rocking direction. As a value of “n” is increased, the number of logical product operations for calculating a product of the previous product an the translationally copied shape will be increased.

Then, in Step S1919, the process is terminated.

If YES in Step S1915, i.e., if the processing for one or more of the rocking directions has not been completed, the process advances to Step S1921, and the solid B is copied (solid Ci0).

Then, in Step S1923, “j” is set to “1”.

In Step S1925, if “j” is equal to or less than “n”, the process advances to Step S1929. The “n” is the number of divided rocking distances (identical to “n” described in Step S1907). That is, when n=1, the subsequent operation will calculate a product of an original shape and a shape obtained by copying the original shape and translating the copied shape by the rocking distance in the rocking direction.

For example, given that the copied shape is translated by P·j/n in the rocking detection (Ti) (to obtain a solid Dij).

Then, in Step S1931, the solid Cij−1 and the solid Dij are subjected to a logic product operation (to obtain solid Cij).

In Step S1399, “j” is incremented by one, and the process advances to Step S1925.

If “j” is equal to or less than “n”, i.e., the coping and the logical product operation for the entire divided rocking distances have not been completed, the above process will be repeated. When “j” is greater than “n”, i.e., the coping and the logical product operation for the entire divided rocking distances have been completed, the process advances to Step S1927, and “I” is incremented by one (which shows that the processing for one of the rocking directions has been completed).

Then, after incrementing “j”, the process advances to Step S1915, the same processing as described above will be performed.

System Configuration

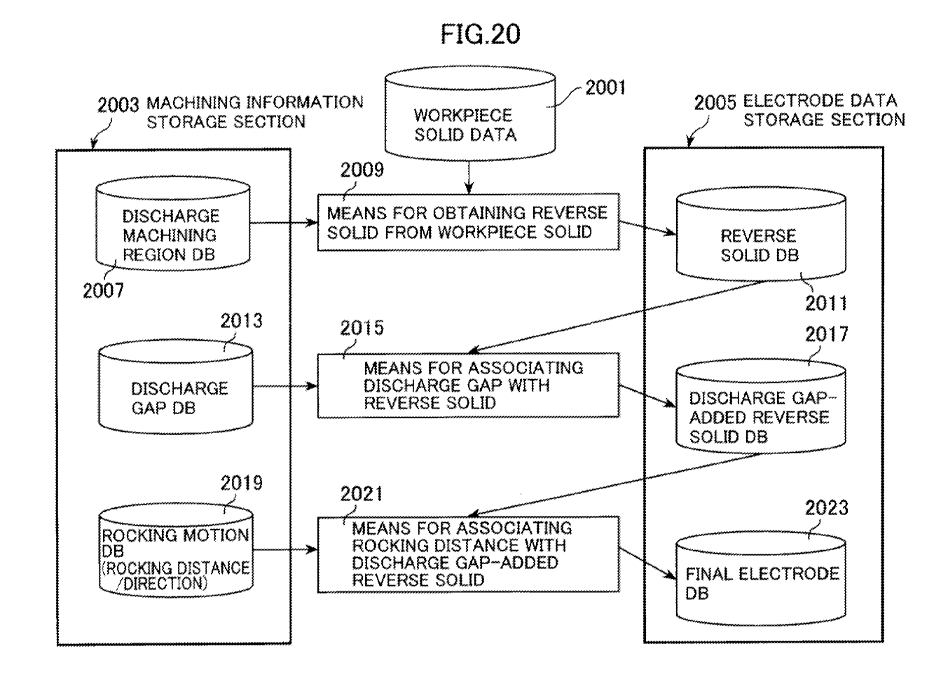

With reference to FIG. 20, the configuration of a system according to one embodiment of the present invention will be described below.

This system is roughly divided into a workpiece solid database 2001, a machining information storage section 2003, and an electrode data storage section 2005.

The workpiece solid database 2001 stores a final shape of a workpiece to be subjected to electric discharge machining.

The machining information storage section 2003 comprises a discharge machining region DB (as used in this specification, the term “DB” means a database) 2007, a discharge gap DB 2013 and a rocking motion DB 2019.

The electrode data storage section 2005 comprises a reverse solid DB 2011, a discharge gap-added reverse solid DB 2017, and a final electrode DB 2023.

Further, processing means includes means 2009 for obtaining a reverse solid from a workpiece solid, means 2015 for associating the discharge gap with a reverse solid, and means 2021 for associating the rocking distance with a discharge gap-added reverse solid.

In this system, a machining region of a workpiece is identified based on information from the workpiece slid DB 2001 an the discharge machining region DB 2007, and stored in the reverse solid DB 2011.

Then, workpiece data having an identified machining region stored in the reverse solid DB 2011, and discharge gap data from the discharge gap DB 2013 are added to the “means 2009 for obtaining a reverse solid for a workpiece solid” to obtain a reverse solid data associated with the discharge gap, and the discharge gap-added reverse solid data is stored in the discharge gap-added reverse solid DB 2017.

Further, the discharge gap-added reverse solid data stored in the discharge gap-added reverse solid DB 2107, and rocking motion data (including the rocking distance and the rocking direction) stored in the rocking motion DB 2019 are added to the “means 2021 for associating the rocking distance with a discharge gap-added reverse solid” to obtain a final electrode data, and the final electrode data is stored in the final electrode DB 2023.

This system may be achieved using a CAD system, which is communicatably connected with a CPU, a memory, a display and an input device (keyboard or the like) through a bus. Alternatively, substantially the same configuration may be achieved only by hardware or may be achieved by a combination of hardware and software.

Other Features

The method and system for designing of electrodes according to the embodiment of the present invention additionally have the following features.

(1) Offset for Discharge Escape Distance

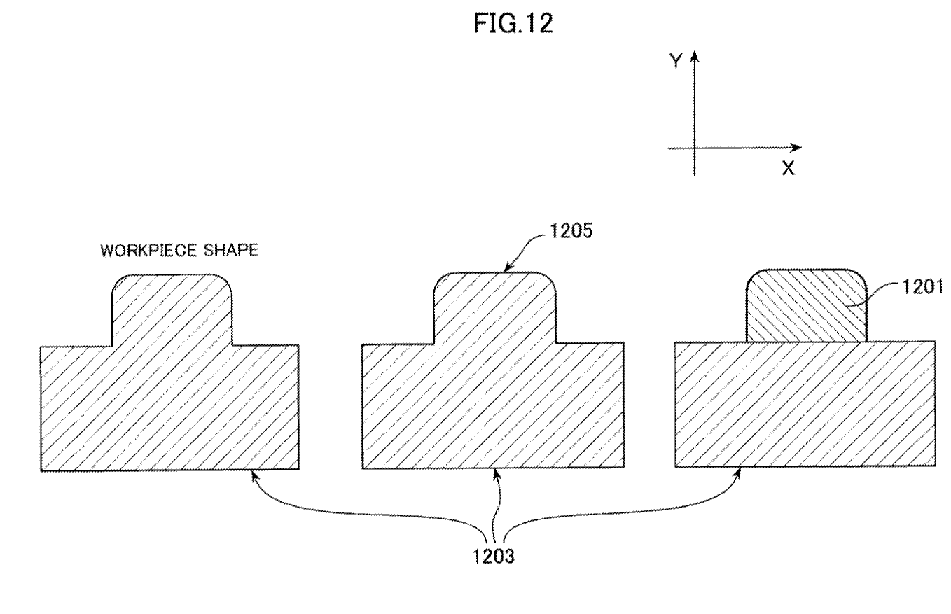

As shown in FIG. 12, when a solid includes a region which has been subjected to a cutting process or a machining process using another electrode and thereby should not be re-subjected to electric discharge machining, an electrode is designed to keep a given distance from the region to allow the region to escape from electric discharge machining (this distance is referred to as “discharge escape distance”).

A discharge electrode may be formed to keep a given distance from only a cap-shaped region 1201 in FIG. 12, so as to allow the region to be not subjected to electric discharge machining even during discharge.

(2) Integral Creation of Seat and Electrode

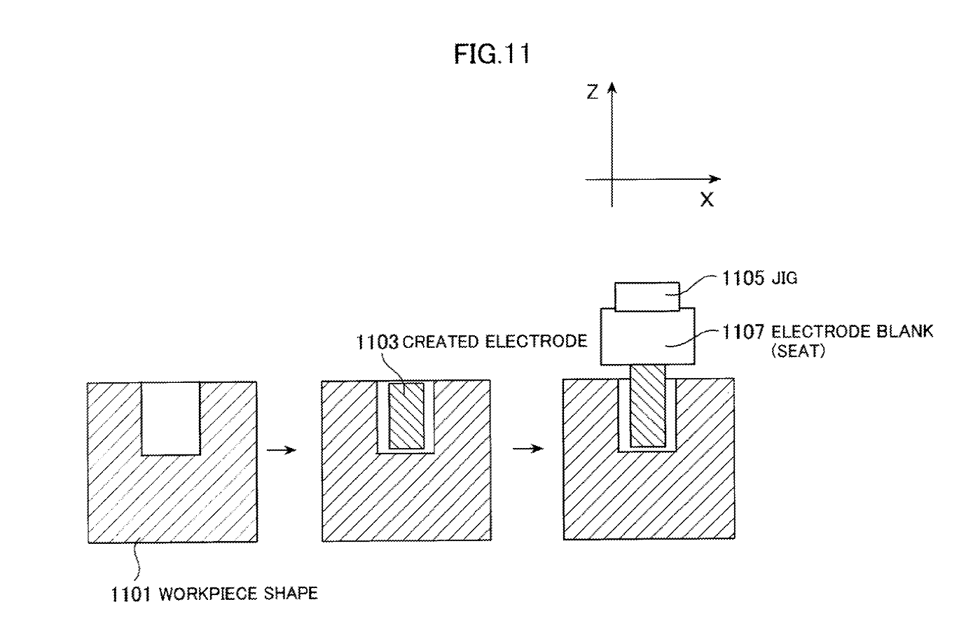

As shown in FIG. 11, during machining process of an electrode, a seat necessary for electric discharge machining is machined together with the electrode in some cases.

Generally, the seat is necessary to allow a jig 1105 for fixing a finished electrode during an actual electric discharge marching process to readily clamp the electrode. Thus, in a process of designing an electrode, a seat (electrode blank) 1107 is added to an electrode shape 1103 obtained from a workpiece shape 1101.

Specifically, the aforementioned process of designing a discharge electrode may further include a step of creating an integral shape of the discharge electrode and a seat, to provide enhanced efficiency.

(3) Technique of allowing electrode to be automatically redesigned when a part of dimensions of workpiece is changed.

When a part of dimensions of workpiece is changed, for example, a hole diameter is reduced to 0.5 mm, after a shape of a discharge electrode is obtained as described above, an electrode shape required for the changed workpiece is aromatically calculated (without an additional manual operation for changing dimensions of the electrode) by use of at least three types of information consisting of (i) information about a region of the workpiece solid which has been used for obtaining a first reverse solid (the reverse shape to the workpiece shape), (ii) information about an offset value of each surface of the first reverse solid which has been offset to obtain a second reverse solid (the discharge gap-added reverse solid to the workpiece shape), and (iii) information about a sweep direction of each solid which has been subjected to the sweep movement, and a combination of the solids which have been subjected to the logical product operation to obtain the third reverse solid (the discharge gap and rocking distance-added reverse solid to the workpiece shape), which have been obtained during creation of the discharge electrode.

(4) Technique of extracting machining information necessary for electric discharge machining which includes machining start position of electrode, rocking distance and rocking direction, from information about electrode and workpiece, and automatically transmitting extracted machining information to electric discharge machine.

The electric discharge machine is a processing machine designed to automatically set a position of an electrode according to a predetermined program, and perform electric discharge machining between the electrode and a workpiece (with a workpiece shape) to transferably machine the workpiece in a desired shape.

After designing an electrode using a CAD system, an actual electrode is fabricated through a cutting process according to the design. Then, the electrode fabricated through the cutting process is attached to the electric discharge machine. A target workpiece is also set up to the electric discharge machine. In this state, if a distance between an origin of the electrode and a machining shape of the electrode, and a distance between an origin of the workpiece and a target shape of the workpiece to be machined, are known, the electrode can be set at a given position of the electric discharge machine in such a manner as to be adequately positioned relative to a target region of the workpiece to be subjected to electric discharge machining.

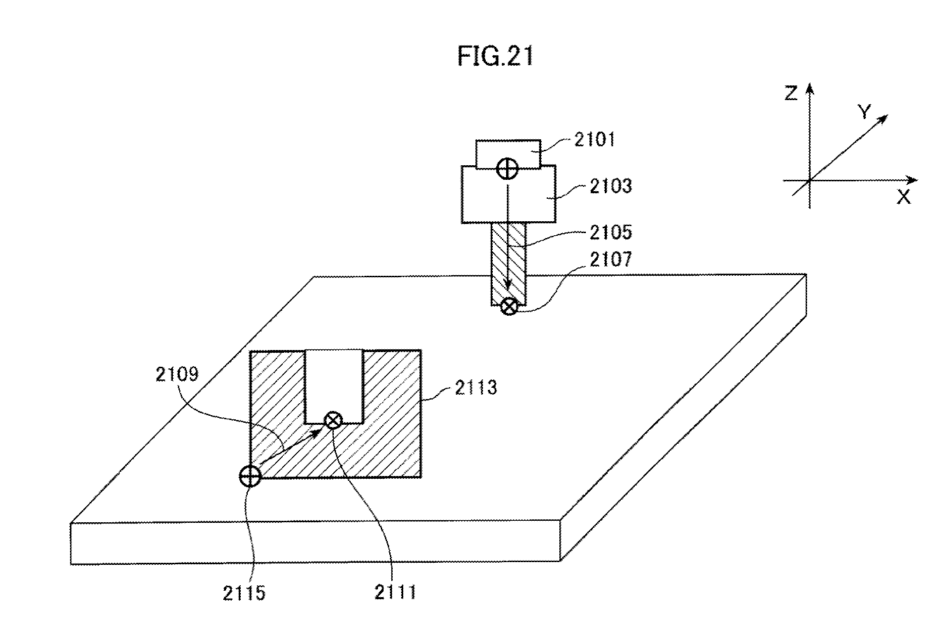

Thus, the electrode can be automatically set at a machining start position by determining the above two distances (FIG. 21).

In FIG. 21, the reference numeral 2101 indicates a jig; 2103 indicates an electrode, 2105 indicates a distance between an origin of the electrode and a machining shape of the electrode; 2107 indicates a given position of the machining shape of the electrode; 2109 indicates a distance between an origin of the workpiece and a target shape of the workpiece to be machined; 2111 indicates a given position of the target shape of the workpiece; 2113 indicates the workpiece; and 2115 indicates the origin of the workpiece.

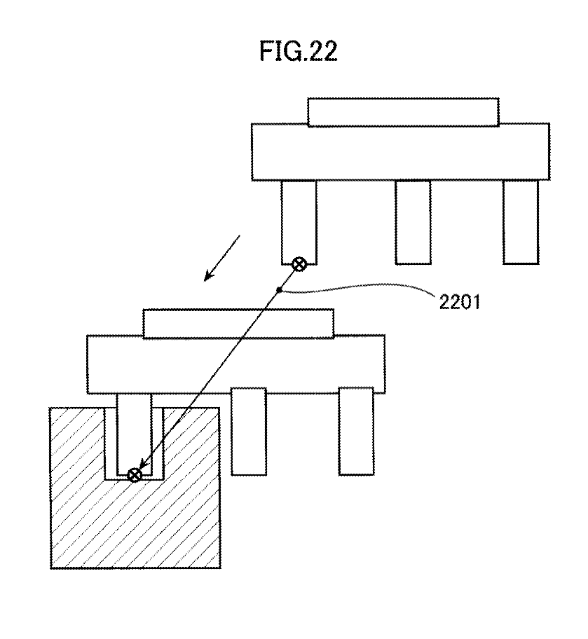

As shown in FIG. 22, each of the electrode and the workpiece can be automatically positioned by identifying respective coordinates of the origins and the given positions thereof to determine a 3-dimensional vector oriented in a direction from a current coordinate to a coordinate of a machining position.

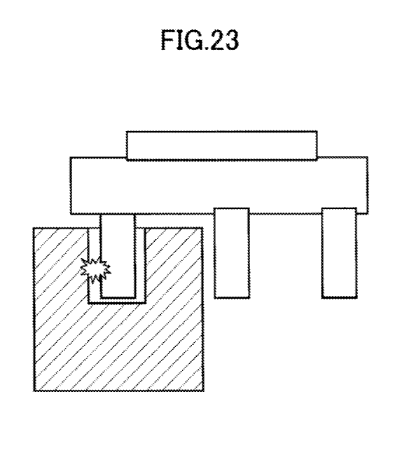

Data to be transmitted from the CAD system to the electric discharge machine includes the machining start position, and a pitch and the number of pitches when the electrode is created by copying a plurality of reverse solids. Further, information abut machining conditions determined by the rocking distance, the rocking pattern and the discharge gap is transferred to the electric discharge machine. FIG. 23, the electric discharge machine may be designed such that the rocking distance, the rocking pattern and other machine conditions are registered in a program as parameters, and parameter values are automatically read in the program, so as to start machining immediately after the positioning.

(5) Technique of, when a target region of the workpiece to be machined by the electrode includes no curved area and an edge which extends between respective pints of two maximum values or two minimum values to have a length greater than a rocking distance in a rocking direction and a parallel relation to the rocking direction, calculating a product of the second reverse solid and a solid created by copying and translating the second reverse solid by said rocking distance.

For example, in a workpiece having a convex cylindrical shape, while an electrode shape can be precisely designed based on a sweep movement, a product of a circle and a circle in a calculation based on a single translational copying results in a formation of an undesirable groove between the circles (see the aforementioned publication). In contrast, when a workpiece has a convex square pole shape, an electrode shape can be precisely designed based on only a single translational copying without a sweep movement.

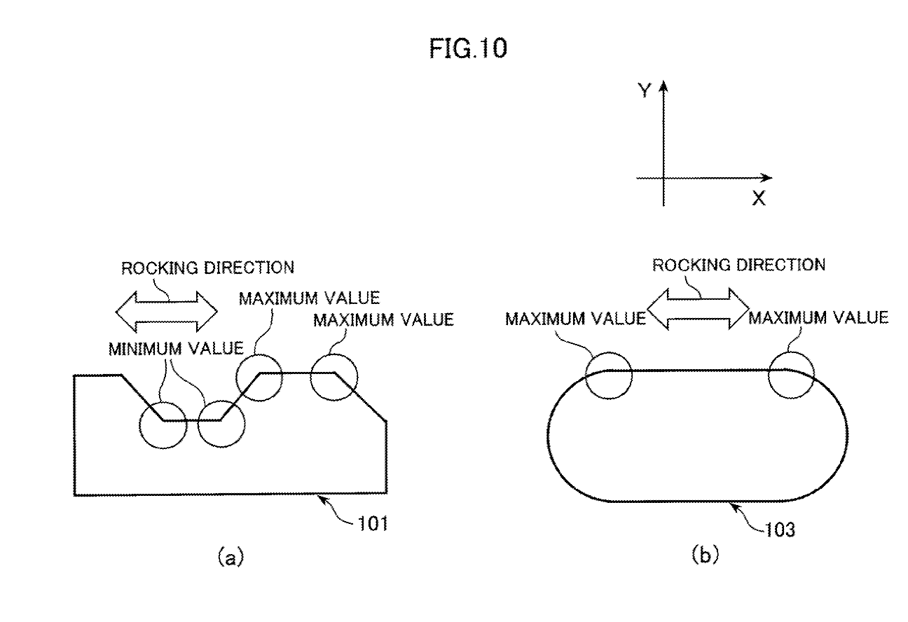

For example, in FIG. 10(a), an edge extending between a minimum value and a maximum value is longer than the rocking distance, and the rocking direction is the X-direction. Thus, an electrode can be adequately designed by translationally copying an original electrode shape by the rocking distance once and subjecting the copied shape and the original shape to a logical product operation. Similarly, in FIG. 10(b), an edge extending between two maximum values is longer than the rocking distance, and the rocking direction is the X-direction. Thus, an electrode can be adequately designed by translationally copying an original electrode shape by the rocking distance once and subjecting the copied shape and the original shape to a logical product operation. Each of the workpiece shapes in FIGS. 10(a) and 10(b) is an example where an electrode can be created without deterioration in shape even by a single translational copying with substantially the same quality as that of a product based on the swept solid.

That is, in the above conditions, as shown in FIG. 10, an electrode solid can be created by translationally copying the uniformly-offset second reverse solid (discharge gap-added reverse shape to the workpiece shape) (101, 103) by the rocking distance in the X-direction, and calculating a product of the original solid and the second reverse solid (discharge gap-added reverse shape to the workpiece shape).

What is claimed:

1. A method for designing an electrode for electric discharge machining of a workpiece, based on a reverse shape to a shape of the workpiece by use of a CAD system, comprising:
(a) Obtaining a first reverse solid having a reverse shape to a shape of the workpiece, from a solid of the workpiece;
(b) Uniformly offsetting an entire surface of said first reverse solid by a thickness necessary for a discharge gap to obtain a second reverse solid; and
(c) Subjecting said second reverse solid and one or more swept reverse solids created by copying said second reverse solid while allowing a sweep movement by a small distance in a direction conforming to a rocking motion, to a logical product (AND) operation to obtain a shape of an electrode as a third reverse solid.

2. The method as defined in claim 1, wherein said step (a) of obtaining the first reverse solid includes the step of defining said workpiece shape as a target region to be subjected to electric discharge machining and a non-target region to be not subjected to electric discharge machining, and, during creating said reverse shape, offsetting said non-target region by a discharge escape distance without subjecting said target region to said offsetting.

3. The method as defined in claim 1, which further includes the step of, after said step (c) of obtaining the shape of the electrode, calculating a sum of the shape of said electrode and a shape of an electrode blank including a square pole shape and a cylindrical shape, to obtain an integral shape of said electrode and said electrode blank.

4. The method as defined in claim 1, which includes allowing the electrode to be automatically redesigned when a part of dimensions of the workpiece including a hole diameter is changed, by use of, in each of said steps (a) to (c) of obtaining the first to third reverse solids, at least three types of information consisting of:
(i) Information about a region of said workpiece solid, which has been used in said step (a) of obtaining the first reverse solid;
(ii) Information about an offset value of each surface of said first reverse solid which has been offset in said step (b) of obtaining the second reverse solid; and
(iii) Information about a sweep direction of each solid which has been subjected to the sweep movement, and a combination of the solids which have been subjected to said logical product operation, in said step (c) of obtaining the third reverse solid.

5. The method as defined in claim 2, which includes allowing the electrode to be automatically redesigned when a part of dimensions of the workpiece including a hole diameter is changed, by use of, in each of said steps (a) to (c) of obtaining the first to third reverse solids, at least three types of information consisting of:
(i) Information about a region of said workpiece solid, which has been used in said step (a) of obtaining the first reverse solid;
(ii) Information about an offset value of each surface of said first reverse solid which has been offset in said step (b) of obtaining the second reverse solid; and
(iii) Information about a sweep direction of each solid which has been subjected to the sweep movement, and a combination of the solids which have been subjected to said logical product operation, in said step (c) of obtaining the third reverse solid.

6. The method as defined in claim 3, which includes allowing the electrode to be automatically redesigned when a part of dimensions of the workpiece including a hole diameter is changed, by use of, in each of said steps (a) to (c) of obtaining the first to third reverse solids, at least three types of information consisting of:
(i) Information about a region of said workpiece solid which has been used in said step (a) of obtaining the first reverse solid;
(ii) Information about an offset value of each surface of said first reverse solid which has been offset in said step (b) of obtaining the second reverse solid; and
(iii) Information about a sweep direction of each solid which has been subjected to the sweep movement, and a combination of the solids which have been subjected to said logical product operation, in said step (c) of obtaining the third reverse solid.

7. The method as defined in claim 1, which further includes the step of extracting machining information necessary for the electric discharge machining which includes a machining start position of the electrode, a rocking distance and a rocking direction, from information about the electrode and the workpiece, and automatically transmitting said extracted machining information to an electric discharge machine.

8. The method as defined in claim 1, wherein said step (c) of obtaining the third reverse solid includes the step of, when a target region of the workpiece to be machined by the electrode includes no curved area and edge which extends between respective points of two maximum values or two minimum values to have a length greater than a rocking distance in a rocking direction and a parallel relation to said rocking direction, calculating a product of the second reverse solid and a solid created by copying and translating the second reverse solid by said rocking distance.

9. An apparatus for designing an electrode for electric discharge machining of a workpiece, based on a reverse shape to a shape of the workpiece by use of a CAD system, comprising:
(a) First-reverse-solid processing means operable to obtain a first reverse solid having a reverse shape to a shape of the workpiece, from a solid of the workpiece;
(b) Second-reverse-solid processing means operable to uniformly offset an entire surface of said first reverse solid by a thickness necessary for a discharge gap to obtain a second reverse solid; and
(c) Electrode-shape processing means operable to subject said second reverse solid and one or more swept reverse solids created by copying said second reverse solid while allowing a sweep movement by a small distance in a direction conforming to a rocking motion, to a logical product (AND) operation to obtain a shape of an electrode as a third reverse solid.

10. The apparatus as defined in claim 9, wherein said first-reverse-solid processing means includes a selective offset means operable to define said workpiece shape as a target region to be subjected to electric discharge machining and a non-target region to be not subjected to electric discharge machining, and, during creating said reverse shape, offset said non-target region by a discharge escape distance without subjecting said target region to said offsetting.

11. The apparatus as defined in claim 9, which further includes integrated-electrode-shape processing means operable to calculate a sum of the shape of said electrode and a shape of an electrode blank including a square pole shape and a cylindrical shape, to obtain an integral shape of said electrode and said electrode blank.

12. The method as defined in claim 9, which further includes electrode redesigned means operable to automatically redesign the electrode when a part of dimensions of the workpiece including a hole diameter is changed, by use of at least three types of information consisting of:
(i) Information about a region of said workpiece solid, which has been used so as to obtain, said first reverse solid;
(ii) Information about an offset value of each surface of said first reverse solid which has been offset so as to obtain the second reverse solid; and
(iii) Information about a sweep direction of each solid which has been subjected to the sweep movement, and a combination of the solids which has been subjected to said logical product operation, so as to obtain the third reverse solid.
